(19) United States
(12) Patent Application Publication
(10) Pub. No.: US 2018/0307365 A1
(43) Pub. Date: Oct. 25, 2018

(54) COORDINATE DETECTION DEVICE AND OPERATING METHOD THEREOF

(71) Applicant: PixArt Imaging Inc., Hsin-Chu County (TW)

(72) Inventors: Yu-Han CHEN, Hsin-Chu County (TW); Han-Shu LIN, Hsin-Chu County (TW); Yi-Hsien KO, Hsin-Chu County (TW)

(21) Appl. No.: 15/877,933

(22) Filed: Jan. 23, 2018

(30) Foreign Application Priority Data
Apr. 24, 2017 (CN) 201710270848.X

(51) Int. Cl. G06F 3/041; G06F 3/044

(52) U.S. Cl. CPC G06F 3/0416; G06F 2203/04104; G06F 2203/04105; G06F 3/044

(57) ABSTRACT

A coordinate detection device including a force detection device and a processor is provided. The force detection device includes a plurality of force sensors arranged in a matrix. Each of the force sensors is configured to output a force signal representing a force value. The processor receives the force signals from the force sensors, and calculates a touch position according to the force signals.

### CROSS REFERENCE TO RELATED APPLICATION

This application claims the priority benefit of Chinese Patent Application Serial Number 201710270848.X, filed on Apr. 24, 2017, the full disclosure of which is incorporated herein by reference.

### BACKGROUND

### 1. Field of the Disclosure

This disclosure generally relates to an interactive system and, more particularly, to a coordinate detection device and a coordinate detection method that identify at least one touch coordinate according to a result of the force detection of a plurality of force sensors arranged in a matrix.

### 2. Description of the Related Art

Because the touch panel allows the user to operate intuitively, it has been broadly applied to various electronic devices, such as personal computers, work stations, flat computers, smart phones, personal digital assistants and so on. However, with the increment of operable functions of the electronic devices, the touch panel only capable of detecting touch positions does not fulfill the consumer requirements.

U.S. Pat. No. 9,377,888 B2 provides an input device that is used to detect measures of force by each of multiple fingers. The input device includes a capacitive sensor, multiple force sensors and a processing system. The capacitive sensor is used to detect positional information of each of multiple fingers. The force sensors are arranged near the perimeter edge of a sensing surface, and each of the force sensors outputs a measure of force. The processing system calculates a force provided by each finger using the matrix equation according to the detected positional information of the fingers and the measures of force.

In said U.S. Patent, operations of the capacitive sensor and the force sensors are independent from each other. That is, the capacitive sensor detects the positional information and the force sensors detect the measures of force, respectively, and then the measures of force are coupled to the positional information by numerical calculation.

The present disclosure provides a coordinate detection device and a coordinate detection method that calculate position information only using the force detection information, or that determine a rough position using the force detection information and then determine a fine position using a touch panel.

### SUMMARY

One object of the present disclosure is to provide a coordinate detection device and a coordinate detection method that use force detection information to calculate position information without using a capacitive, an inductive, a resistive, an optical or an acoustic touch panel.

Another object of the present disclosure is to provide a coordinate detection device and a coordinate detection method that firstly determine a rough position using force detection information and then determine a fine position using a touch panel, wherein after the rough position is determined, only a part of a sensing region of the touch panel is turned on and the rest part is turned off to reduce the total power consumption.

The present disclosure provides a coordinate detection device configured to detect at least one touch position of at least one object on a touch surface thereof. The coordinate detection device includes a force detection device and a processor. The force detection device includes a plurality of force sensors arranged under the touch surface, and each of the force sensors is configured to output a force signal corresponding to an external force when the at least one object presses on the touch surface with the external force. The processor is electrically coupled to the force sensors, and configured to identify at least one object region of the at least one object on the touch surface according to the force signal, and respectively calculate a touch position corresponding to each of the object according to the force signal of the force sensor within the at least one object region.

The present disclosure further provides a coordinate detection device configured to detect at least one touch position of at least one object on a touch surface thereof. The coordinate detection device includes a force detection device, a processor and a touch panel. The force detection device includes a plurality of force sensors arranged under the touch surface, and each of the force sensors is configured to output a force signal corresponding to an external force when the at least one object presses on the touch surface with the external force. The processor is electronically coupled to the force sensors, and configured to identify at least one object region of the at least one object on the touch surface according to the force signal, and output a region control signal according to the at least one object region. The touch panel includes a plurality of detecting cells under the touch surface, and is configured to turn on detecting cells, among the plurality of detecting cells, corresponding to the at least one object region according to the region control signal to detect at least one fine position mad turn off detecting cells, among the plurality of detecting cells, outside the object region.

The present disclosure further provides a coordinate detection method of a coordinate detection device. The coordinate detection device includes a touch surface, a plurality of force sensors arranged under the touch surface and a processor. The coordinate detection method includes: respectively outputting, by each of the plurality of force sensors, a force signal when at least one object presses on the touch surface with an external force, wherein a value of the force signal is positively correlated with an amount of the external force; and identifying, by the processor, at least one object region of the at least one object on the touch surface according to the force signal, and calculating, by the processor, a touch position corresponding to each of the object according to the force signal of the force sensor within the at least one object region.

The present disclosure further provides a coordinate detection device including a self-capacitance device, a force detection device and a processor. The self-capacitance device is configured to detect multiple touch coordinates of multiple objects on a touch surface. The force detection device includes a plurality of force sensors arranged under the touch surface, and each of the force sensors is configured to output a force signal corresponding to an external force when the multiple objects press on the touch surface with the external force. The processor is electrically coupled to the force detection device and the self-capacitance device, and configured to select a part of touch coordinates among the multiple touch coordinates as output coordinates according to force signals corresponding to the multiple touch coordinates.

The coordinate detection device and the coordinate detection method of the present disclosure further calculate an applied force value corresponding to each object according to the force signal, wherein the force signal is a voltage value, a current value, a voltage function or a current function representing the force value.

### BRIEF DESCRIPTION OF THE DRAWINGS

Other objects, advantages, and novel features of the present disclosure will become more apparent from the following detailed description when taken in conjunction with the accompanying drawings.

FIG. 1 is a block diagram of a coordinate detection device according to a first embodiment of the present disclosure.

FIG. 2 is a cross sectional view of a force detection device according to an embodiment of the present disclosure.

FIG. 3 is an operational schematic diagram of the force detection according to an embodiment of the present disclosure.

FIG. 4A is a schematic diagram of output force values of force sensors and a single threshold of the single-point touch in FIG. 3.

FIG. 4B is a schematic diagram of output force values of force sensors and two thresholds of the multi-point touch along a line 4B-4B′ in FIG. 3.

FIG. 5 is a block diagram of a coordinate detection device according to a second embodiment of the present disclosure.

FIG. 6 is an operational schematic diagram of a coordinate detection device according to a second embodiment of the present disclosure.

FIG. 7 is a flow chart of a coordinate detection method of a coordinate detection device according to an embodiment of the present disclosure.

### DETAILED DESCRIPTION OF THE EMBODIMENT

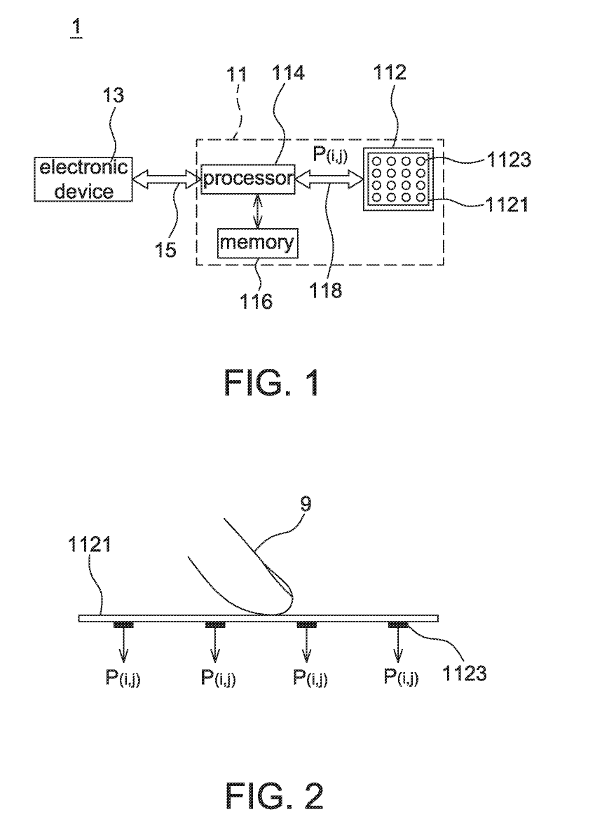

Referring to FIG. 1, it is a block diagram of a coordinate detection device 1 according to a first embodiment of the present disclosure. The coordinate detection device 1 is a portable electronic system or an immovable electronic system such as a human-machine interactive device including a smart phone, a personal computer, a personal digital assistant, a tablet computer, a work station, a vehicle central control system or a smart home appliance, but not limited to.

The coordinate detection device 1 includes a force detection device 11 and an electronic device 13 electrically coupled together and transmitting signals (e.g., detected signals, control signals and so on) therebetween through a transmission line 15, wherein the transmission line 15 is, for example, a bus line or a signal line, and the force detection device 11 and the electronic device 13 both have a communication interface to perform the data exchange. The force detection device 11 and the electronic device 13, for example, form a single device or form two separated but electrically coupled devices.

The force detection device 11 includes a display module 112, a processor 114 and a memory 116, wherein the display module 112 and the processor 114 are electrically coupled together and transmitting signals (e.g., detected signals, display signals, control signals and so on) therebetween through a transmission line 118. For example, the processor 114 is used to control pictures shown by the display module 112 and receive the force signal P (i,j) detected by the display module 112, wherein the force signal P (i,j) is a voltage signal or a current signal whose value is positively correlated with an amount of an external force being applied (illustrated below with an example). For example, when the external force is increased, the value of the force signal P (i,j) is linearly or non-linearly increased; whereas, when the external force is decreased, the value of the force signal P (i,j) is linearly or non-linearly decreased.

The display module 112 includes a touch surface 1121 and a plurality of force sensors 1123 arranged under the touch surface 1121 (e.g., FIG. 1 showing that the force sensors 1123 are arranged in a matrix, but not limited to). In some embodiments, the touch surface 1121 is overlapped with a display surface of the display module 112 to allow the user to operate intuitively (e.g., click, slide thereon). In some embodiments, the touch surface 1121 is arranged separately from the display surface of the display module 112 (i.e. not overlapped with each other) according to different applications. The display module 112 further includes other buttons for being pressed by the user.

In other words, although the present disclosure is illustrated by integrating the touch surface 1121 and the force sensors 1123 in the display module 112, it is not to limit the present disclosure. In other embodiments, the touch surface 1121 and the force sensors 1123 are arranged separately from the display module 112 to form another force detection module. For example, the coordinate detection device 1 includes a display surface for showing pictures, and further includes a touch surface 1121 for user operation. In this way, a user does not perform the touch control on the display surface, and various predetermined operations are performed without blocking the pictures shown thereon.

As shown in FIG. 2, when at least one object 9 (e.g., the conductor such as a finger or stylus) presses on the touch surface 1121 with an external force, each of the force sensors 1123 is used to output a force signal P (i,j) corresponding to the external force, wherein (i,j) indicates a position in the matrix and i, j are positive integers. Generally, a value of the force signal P (i,j) closer to the object 9 is larger and the force signals P (i,j) farther from the object 9 have smaller values, and the decrement of the value with the distance is determined by the material of the touch surface 1121. The force signal P (i,j) is sent to the processor 114 via the transmission line 118 to be post-processed. The force signal P (i,j) is an analog signal or a digital signal, i.e. the display module 112 (or force detection module) may or may not include an analog to digital converter (ADC). When the display module 112 does not include the ADC, the force signal outputted by the display module 112 is analog raw data. In this case, the processor 114 includes an ADC for the analog-digital conversion.

For example, the force sensors 1123 successively output the force signals P(i,j) within a scan period. For example, a plurality of switching devices or a multiplexer is arranged between a drive circuit (not shown) and the force sensors 1123, and a plurality of switching devices or a multiplexer is arranged between a read circuit (not shown) and the force sensors 1123. The signal driving and the signal reading of the force sensors 1123 are controlled by controlling the switching devices or the multiplexers. Only the force sensors 1123 connected to both the drive circuit and the read circuit can output the force signal P (i,j). In other words, the switching devices and the multiplexers determine whether a force sensor 1123 is turned on or turned off.

In the present disclosure, the force sensors 1123 are piezoelectric force sensors, capacitive force sensors or resistive force sensors without particular limitations. The force signals P (i,j) detected and outputted by the force sensors 1123 vary positively in a linear or non-linear manner with respect to the amount of external force.

The memory 116 includes, for example, a non-volatile storing device (e.g., ROM or flash memory) and a volatile storing device (e.g., RAM). The non-volatile storing device stores the predetermined value (e.g., threshold), algorithm and program required in the operation of the coordinate detection device 1. When the coordinate detection device 1 starts to operate, a part of program is loaded from the non-volatile storing device to the volatile storing device to start operation. The volatile storing device is further used to temporarily store force signal information from the display module 112 to be accessed by the processor 114 during operation to accordingly identify at least one touch position and corresponding force value.

The processor 114 is, for example, a central processing unit (CPU), a microcontroller unit (MCU), a graphic processing unit (GPU) or an application specific integrated circuit (ASIC) that implement various functions by software and/or hardware, and electrically coupled to the memory 116 and the force sensors 1123. For example, the processor 114 includes hardware and/or software codes for calculating the force signal data from the display module 112 and accessing the memory 116 according to the predetermined algorithm. The processor 114 is used to identify at least one touch position, e.g., a single touch position or multiple touch positions, of at least one object 9 on the touch surface 1121 according to the force signals P(i,j), and calculate an output force value corresponding to each touch position (illustrated below with an example). For example, the processor 114 identifies at least one object region of at least one object 9 on the touch surface 1121 according to the force signals P(i,j) at first, and then calculates a touch position corresponding to each object 9 according to the force signals P(i,j) of the force sensors 1123 within the at least one object region. The processor 114 then controls an external electronic device 13 according to the single touch position or multiple touch positions and the position variation with time thereof.

It should be mentioned that although FIG. 1 shows that the processor 114 is included in the force detection device 11, e.g., the force detection device 11 being modulized to be arranged in a housing, and connected with the electronic device 13 via the transmission line 15 and power line, but the present disclosure is not limited thereto. In other embodiments, the force detection device 11 and the electronic device 13 have a respective processor, or the processor 114 is disposed in the electronic device 13 without particular limitations. More specifically, the processor 114 may be arranged properly as long as it is in the coordinate detection device 1.

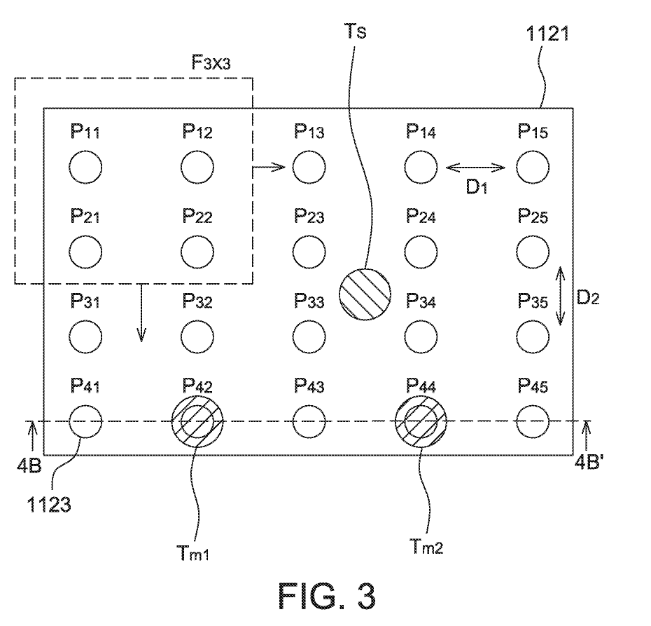

Referring to FIG. 3, it is an operational schematic diagram of the force detection according to an embodiment of the present disclosure. In identifying a single touch position Ts, a proper method may be used. For example in one embodiment, the processor 114 identifies a single touch position Ts of a single object according to a maximum value of the force signals P(i,j), wherein the maximum value is preferably larger than a predetermined threshold to remove noises. This method is adaptable to an embodiment having a lower accuracy requirement, but has the merit of fast calculation speed. In another embodiment, the processor 114 identifies a maximum value of the force signals P(i,j) and a predetermined area surrounding the maximum value as a single object region, and calculates a single touch position Ts corresponding to the object by interpolation operation using every force signal within the single object region, wherein said predetermined area is previously determined and stored in the memory 116 according to, for example, a size and resolution of the touch surface 1121 and/or the detection resolution of the coordinate detection device 1.

For example, within one scan period, the force sensors 1123 sequentially output force values P₁₁ to P₄₅, which are voltage values or current values, and the processor 114 sequentially compares the force values P₁₁ to P₄₅ by hardware and/or software. For example, within the scan period, all the force values P₁₁ to P₄₅ are firstly stored in the memory 116, and then the maximum value of the stored force values P₁₁ to P₄₅ is calculated. Then, a position of the force sensor 1123 corresponding to said maximum force value is used as the single touch position Ts. Or, as mentioned above, a single object region is determined at first and then the single touch position Ts is calculated.

In another embodiment, within one scan period, the processor 114 sequentially compares two force values received at different times (e.g., comparing P₁₁ with P₁₂, P₁₂ with P₁₃, . . . , P₄₃ with P₄₄, and P₄₄ with P₄₅), and temporarily stores information of the larger force value (e.g., including force value, position and so on) among the compared two force values in a register without storing information of the smaller force value among the compared two force values. When a new larger force value appears, the stored information in the register (e.g., included in the memory 116 or the processor 114) is updated till the scan period is over. In this way, a maximum force value is obtainable, and a position of the force sensor 1123 associated with the maximum force value is taken as the single touch position Ts; or, as mentioned above, a single object region is determined at first and then the single touch position Ts is calculated.

In another embodiment, the processor 114 identifies the at least one touch position, by interpolation operation, using multiple force signals, which are larger than a first threshold TH1, among all force signals P(i,j) (e.g., force signals P₁₁ to P₄₅). For example, the processor 114 identifies a range of multiple force signals (corresponding to a range of the touch surface 1121), which are larger than the first threshold TH1, among the plurality of force signals P(i,j) as at least one object region, and calculates, by interpolation operation, the touch position corresponding to each object using the multiple force signals within the at least one object region.

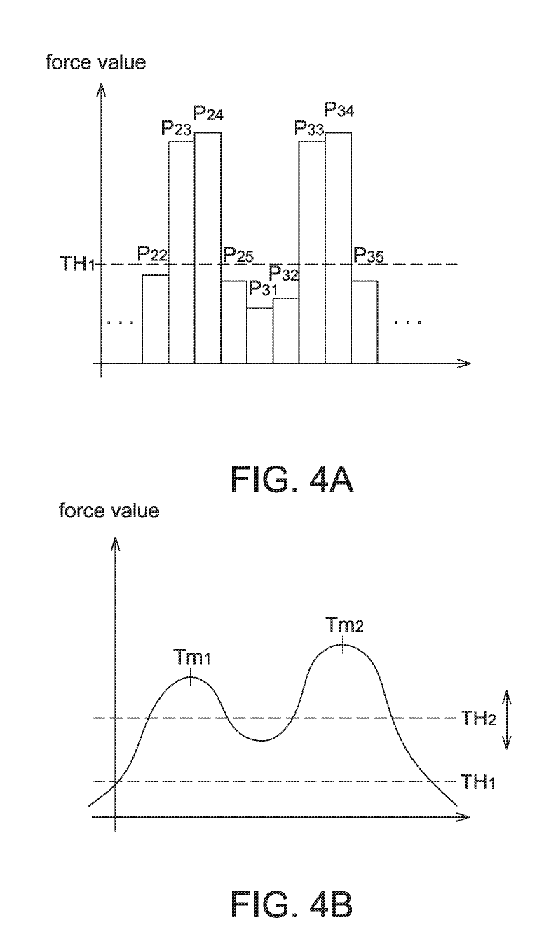

For example referring to FIGS. 3 and 4A, when a single object 9 presses on a single touch position Ts, it is assumed that only force values P₂₃, P₂₄, P₃₃ and P₃₄ of the force sensors adjacent to the single touch position Ts exceed the first threshold TH1. As mentioned above, in the present disclosure the processor 114 stores all force signals P(i,j) at first and then performs the comparison, or stores only the force signals P(i,j) larger than the first threshold TH1. The processor 114 then calculates the single touch position Ts according to the force values P₂₃, P₂₄, P₃₃ and P₃₄ and the sensing pitches D₁ and D₂, wherein D₁ and D₂ may or may not be identical without particular limitations. D₁ and D₂ are preferably arranged according to a width of the finger, e.g., generally between 5 mm and 11 mm. For example, when the force values P₂₃, P₂₄, P₃₃ and P₃₄ are all identical, the single touch position Ts is at a center of the force sensors 1123 associated with the force values P₂₃, P₂₄, P₃₃ and P₃₄. When one of the force values P₂₃, P₂₄, P₃₃ and P₃₄ is larger, the single touch position Ts shifts toward a position of the force sensor 1123 associated with the larger force signal. The algorithm associated with this method (i.e. one interpolation operation herein) is previously stored in the memory 116. This example is adaptable to an embodiment which requires higher position accuracy, but it requires more system resources.

In another embodiment, the processor 114 identifies a maximum force signal P(i,j), e.g., force value P₂₄, and a predetermined area surrounding thereto (e.g., including force sensors adjacent thereto) as an object region, and then calculates the single touch position Ts, by interpolation operation, using the force values within the object region (e.g., the P₂₃, P₁₄, P₂₅ and P₃₄) in conjunction with the sensing pitches D₁ and D₂. The above force values of the force sensors adjacent to the force value P₂₄ further include P₁₃, P₁₅, P₃₃ and P₃₅ according to different applications.

In another embodiment, if a simpler algorithm is adopted, the processor 114 takes a gravity center of the force sensors 1123 associated with multiple force signals P(i,j) exceeding the first threshold TH1 as the single touch position Ts. For example, when the multiple force signals, which are larger than the first threshold TH, include other farther force signals (depending on the adopted force detection device) in addition to the adjacent force values P₂₃, P₂₄, P₃₃ and P₃₄, more system resources are required by using the above interpolation algorithm and thus it is possible to select a simpler method.

As mentioned above, the processor 114 calculates a single touch position Ts according to at least one force signal P(i,j) as long as the used algorithm is coded in hardware and/or software previously.

In addition, to increase the identification accuracy, the processor 114 filters the force signals P(i,j) using a digital filter before comparing the force signals P(i,j) with the first threshold TH. For example, FIG. 3 shows an example of a digital filter F_{3×3}. In one embodiment, the digital filter F_{3×3} is shown as equation (1), but not limited thereto,

$${F}_{3 \times 3} = [ \begin{matrix}0.1 & 0.1 & 0.1 \\ 0.1 & 1 & 0.1 \\ 0.1 & 0.1 & 0.1\end{matrix} ] . \qquad ( equation 1 )$$

Before the comparison, the processor 114 sequentially filters the force signals P(i,j) (e.g., storing as a matrix form) using the digital filter F_{3×3}, and then the single touch position Ts is calculated by the above several methods using the filtered force signals. In the filtering, force values outside edges of the force sensors (e.g., values at the upper side, left side and left-upper side of P₁₁, values at the upper side of P₁₂) are filled with values using mapping or edge extension for the filtering operation, and said mapping or edge extension is known to the art and thus details thereof are not described herein.

Referring to FIG. 3 again, in an example of multi touch, two or more objects (e.g., two objects at positions Tₘ₁ and Tₘ₂ shown in FIG. 3) appear on the touch surface 1121. When a distance between touch positions of the two objects is close, it is possible that force signals P(i,j) between the two touch positions Tₘ₁ and Tₘ₂ are larger than the first threshold TH1 as shown in FIG. 4B.

In FIG. 4B, for explanation purposes, continuous force signals P(i,j) are shown. In this case, to distinguish different objects, the processor 114 further uses a second threshold TH2 to perform the object segmentation, wherein the second threshold TH2 is determined dynamically according to the value of local extremes (e.g., values corresponding to Tₘ₁ and Tₘ₂). When the local extreme is larger, a larger second threshold TH2 is selected; whereas, when the local extreme is smaller, a smaller second threshold TH2 is selected.

For example, the processor 114 identifies a touch region according to multiple force signals, among all force signals P(i,j), larger than a first threshold TH1, and when identifying that an area of the touch region is larger than a predetermined scale (e.g., a single finger surface being about 10 mm×10 mm, and a ratio of which is used to set the predetermined scale), the processor 114 confirms a multi touch mode. Accordingly, the processor 114 identifies multiple touch positions corresponding to multiple objects according to a comparison result of comparing the multiple force signals within the touch region with the second threshold TH2. For example, after removing the force signal (e.g., P₄₃) within the touch region and smaller than the second threshold TH2 (i.e. only keeping the force values larger than the second threshold TH2), the processor 114 confirms two smaller touch regions (i.e. multiple object regions). Next, regarding each new touch region (or object region), the processor 114 calculates a single touch position of each new touch region by using the above method of calculating the single touch position (e.g., taking a position of the force sensor corresponding to a maximum value, such as the local extreme of the force signals P(i,j), within each new touch region as the touch position, or calculating the touch position by interpolation operation using the force signals within each new touch region). In this way, the touch position corresponding to every object in the multi-touch is obtainable.

When the touch region has an area smaller than the predetermined scale, a single touch operation is performed. In other words, the processor 114 determines the algorithm being used according to the touch region so as to calculate a single touch position Ts or multiple touch positions Tₘ₁ and Tₘ₂.

In this embodiment, the first threshold TH1 is different from the second threshold TH2. According to the method of post-processing the force signals P(i,j) of the force sensors 1123, the first threshold TH1 is larger than or smaller than the second threshold TH2. And, values of the first threshold TH1 and the second threshold TH2 are preferably set and stored in the memory 116 before shipment according to the type of the force sensors 1123 being used. In some embodiments, the coordinate detection device 1 has a user interface for the user to adjust the first threshold TH1 and the second threshold TH2 by him/herself.

In some embodiments, the processor 114 further calculates force values corresponding to the at least one object according to the force signals P(i,j). Referring to FIG. 3 again, in a single touch scenario, it is assumed that the single touch position is Ts, and the processor 114 takes a sum or an average of multiple force signals (e.g., P₂₃, P₂₄, P₃₃ and P₃₄) surrounding the single touch position Ts and exceeding the first threshold TH1 as a pressing force (i.e. external force) of the object 9 associated with the single touch position Ts.

In other embodiments, the processor 114 also considers force signals farther from the single touch position Ts (e.g., P₁₂, P₁₃, P₁₄, P₁₅, P₂₂, P₂₅, P₃₂, P₃₅, P₄₂, P₄₃, P₄₄ and P₄₅, which exceed or do not exceed the first threshold TH1) when calculating the pressing force, only the farther force signals being given a smaller weighting and the closer force signals being given a larger weighting. Then the processor 114 calculates the weighted average or weighted sum to obtain the pressing force of the object 9 associated with the single touch position Ts, wherein values of the weighting is determined according to different applications.

Regarding the calculation of the pressing force of each object in the multi-touch, as long as the touch position (e.g., Tₘ₁ and Tₘ₂) associated with each object is obtained at first, the force value is respectively obtained using the above method in the single touch, and thus details thereof are not repeated herein.

More specifically, the coordinate detection device 1 previously stores the identification algorithm for identifying the single touch or multi-touch according to a touch area. When the single touch is the case, the processor 114 calculates a single touch position and the corresponding force value according to the built-in positioning algorithm. When the multi-touch is the case, the processor 114 performs the segmentation algorithm at first to separate multiple positions, and then performs the positioning algorithm (e.g., similar to the single touch case) to calculate every touch position and corresponding force values. These algorithms are implemented by software and/or hardware.

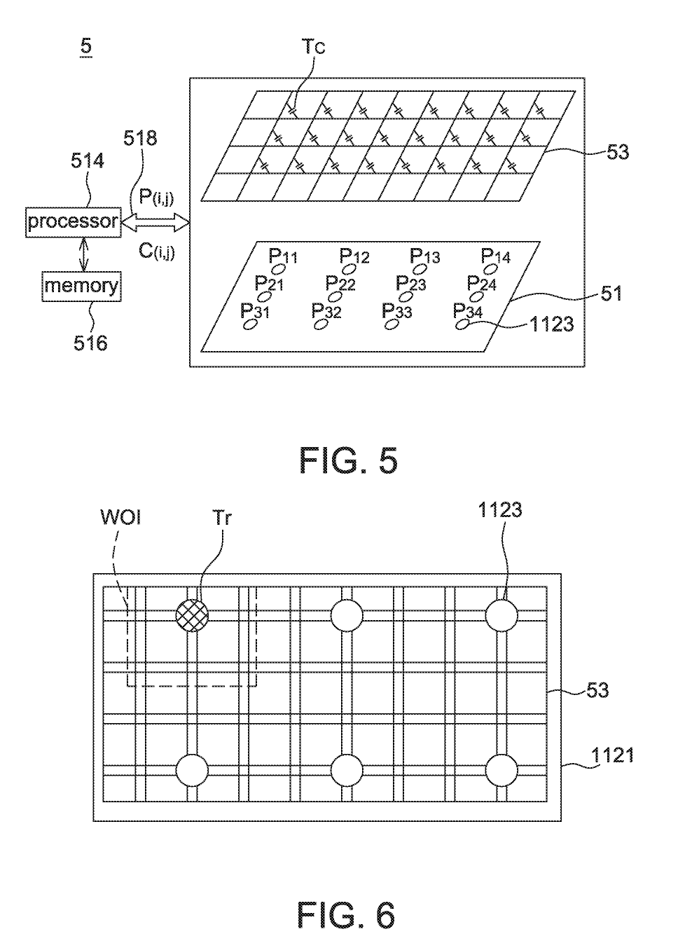

Referring to FIG. 5, it is a block diagram of a coordinate detection device 5 according to a second embodiment of the present disclosure. The difference between the coordinate detection device 5 of the second embodiment and the coordinate detection device 1 of the first embodiment is that, the coordinate detection device 5 further includes a touch panel 53, wherein the touch panel 53 is a capacitive, an inductive, a resistive, an optical or an acoustic touch panel, but not limited thereto. The touch panel 53 is used to detect the proximity operation and touch operation of at least one object on the touch surface. For simplification, FIG. 5 does not show the electronic device and the transmission line for coupling with the electronic device. Regarding the touch panel 53 of the present disclosure, the detected value of the touch panel 53 does not have considerable variation when the force applied by an object 9 in contact with the touch surface 1121 is changed.

As shown in FIG. 5, the coordinate detection device 5 includes a force detection device 51, a touch panel 53, a processor 514, a memory 516 and a transmission line 518, wherein in addition to transmitting the force signals P(i,j), the transmission line 518 also transmits touch signals C(i,j), and the form of the touch signals C(i,j) is determined according to the type of the touch panel 53. In FIG. 5, a mutual capacitive touch panel is taken as an example for illustration.

In this embodiment, the coordinate detection device 5 is also used to detect at least one touch position of at least one object on the touch surface 1121 thereof. As mentioned above, the touch surface 1121 is overlapped with or separated from a display surface according to different applications. In this embodiment, the touch panel 53 is preferably overlapped with the force detection device 51 to allow the touch panel 53 to detect a touch position of an object when the object is giving an external force on the force detection device 51.

In this embodiment, the implementation and operation of the force detection of the force detection device 51, the processor 514 and the memory 516 are identical to those of the first embodiment. The difference is that in this embodiment, a touch position detected by the force detection device 51 is used to determine an object region but not outputted from the device. The processor 514 determines an operable region (corresponding to the object region or determined according to the touch position) of the touch panel 53 according to the object region to save power.

As mentioned above, when at least one object presses on the touch surface 1121 with an external force, each of the plurality of force sensors 1123 (e.g., associated with P₁₁ to P₃₄) of the force detection device 51 is also used to output a force signal P(i,j) corresponding to the external force. The processor 514 is electrically coupled to the force sensors 1123 to receive force signals P(i,j) (e.g., force values P₁₁ to P₃₄) via the transmission line 518. Meanwhile, the processor 514 identifies, using the methods in the above first embodiment, at least one object region or at least one touch position of at least one object 9 on the touch surface 1121 according to the force signals P(i,j).

For example, the processor 514 identifies at least one rough position (i.e. the touch position), by interpolation operation, using multiple force signals, among the plurality of force signals P(i,j), larger than a first threshold TH1 (as shown in FIGS. 3 and 4A). That is, the single touch position Ts mentioned above is used as a rough position in this embodiment, and details thereof have described above. In the embodiment without using the interpolation, the processor 514 identifies at least on local extreme of multiple force signals, among the plurality of force signals P(i,j), larger than the first threshold TH1 and a predetermined area surrounding the local extreme as the at least one object region, wherein the local extreme is referred to one force signal whose adjacent force signals are larger than or smaller than the one force signal. In another embodiment, the processor 514 directly identifies a range of multiple force signals, among the plurality of force signals P(i,j), larger than the first threshold TH1 as the at least one object region.

In the multi-touch scenario, the processor 514 identifies a touch region according to multiple force signals, among the plurality of force signals P(i,j), larger than a first threshold TH1, and identifies multiple object regions according to a comparison result of comparing the multiple force signals within the touch region with a second threshold TH2 (referring to FIGS. 3 and 4B), and as the identification method has been illustrated above, details thereof are not repeated herein.

In another embodiment, regarding the embodiment of multi-touch, the processor 514 is not limited to distinguish respective touch positions, but identifies multiple force signals, among the plurality of force signals P(i,j), larger than a first threshold TH1 as an object region (e.g., the region including all multiple force signals larger than the first threshold TH1). In other words, in this embodiment the processor 514 does not perform the object segmentation even identifying that the touch region is larger than a predetermined scale. The processor 514 takes the whole touch region as the object region, and the touch panel 53 will identify the fine touch position later.

In this embodiment, the method of determining the object region and the touch position is similar to those of the first embodiment.

Meanwhile, the processor 514 outputs a region control signal to the touch panel 53 according to the at least one object region or touch position. In this embodiment, the touch panel 53 includes a plurality of detecting cells Tc arranged under the touch surface 1121 (e.g., the detecting cells Tc being shown as arranged in a matrix, but not limited thereto), wherein each of the detecting cells Tc is, for example, the mutual capacitance between one drive electrode and one receive electrode, or the self-capacitance between one electrode and the common electrode. In other words, the touch panel 53 is a mutual capacitance device or a self-capacitance device without particular limitations. In this embodiment, the detecting cells Tc are different corresponding to the type of the touch panel 53, and indicate the position corresponding to the output detected signal. The touch panel 53 turns on, according to the region control signal, detecting cells Tc, among all detecting cells Tc, only within a predetermined area surrounding the at least one rough position or only corresponding to the at least one object region to detect at least one fine position, and turns off detecting cells Tc, among all detecting cells Tc, outside the predetermined area or not corresponding to the object region.

Please referring to FIG. 6, it is an operational schematic diagram of a coordinate detection device according to a second embodiment of the present disclosure. For example, when the processor 514 identifies a rough position Tr (e.g., the above Ts, Tₘ₁, Tₘ₂) according to the force signals P(i,j) outputted by the force sensors 1123, the processor 514 determines a predetermined area WOI surrounding the touch position Tr, and sends a region control signal to the touch panel 53 via the transmission line 518. As mentioned above, it is possible that the processor 514 directly identifies an object region. After the touch panel 53 receives the region control signal, only the detecting cells Tc within the predetermined area WOI or the object region are turned on, and other detecting cells Tc are turned off. Touch signals C(i,j) of the turned-on detecting cells Tc are outputted to the processor 514 via the transmission line 518. The touch signals C(i,j) are analog signals or digital signals.

In this embodiment, turning on a detecting cell Tc is referred to that, for example, a switching device or a multiplexer connected thereto is conducted such that a drive signal drives the detecting cell Tc and a detected signal is read from the detecting cell Tc. It should be mentioned that the predetermined area WOI and the object region are not limited to have a square shape, but have a circular shape or other predetermined shapes. For example, the predetermined area WOI is formed by extending a predetermined distance from a center, a gravity center or an edge of the at least one rough position.

It should be mentioned that although FIG. 6 shows that the force sensors 1123 of the force detection device 51 and the detecting cells (e.g., Tc) of the touch panel 53 are overlapped along a normal direction of the touch surface 1121, the present disclosure is not limited thereto. In other embodiments, the force sensors 1123 are partially overlapped or not overlapped with the detecting cells Tc along the normal direction according to different applications.

In addition, to further reduce the total power consumption, all detecting cells Tc of the touch panel 53 are turned off before the region control signal is received. The “turned off” herein is referred to that a drive signal is not sent to the detecting cells Tc or the touch panel 53 is in a full sleep mode. Accordingly, the region control signal is also considered as a signal for ending the sleep mode to wake up the touch panel 53. In some embodiments, when the touch panel 53 is turned on, the force detection device 51 temporarily stops detecting force. In some embodiments, the force values detected before the force detection device 51 is temporarily deactivated are stored in the memory 516 to be used after the force detection device 51 is deactivated.

After the touch panel 53 is turned on, at least one fine position corresponding to the object 9 is detected based on a scan frequency. In some embodiments, a number of the at least one fine position is equal to a number of the at least one rough position (or object region). When the number of the at least one fine position is not equal to the number of the at least one rough position (or object region), the coordinate detection device 51 re-detects at least one rough position (or object region) using the force detection device 51. The method of detecting the touch position using a touch panel is known to the art and thus details thereof are not described herein.

Similarly, the processor 514 further calculates force values corresponding to each fine position according to the force signals P(i,j). It should be mentioned that, in this embodiment the processor 514 does not calculate the force values corresponding to the at least one rough position (or object region). The method of calculating each force value is identical to the first embodiment, e.g., calculating a sum, an average or a weighted average of force signals (e.g., detected before or after the touch panel 53 being activated) of the force sensors 1123 close to the fine position, and details thereof have been illustrated above and thus not repeated herein.

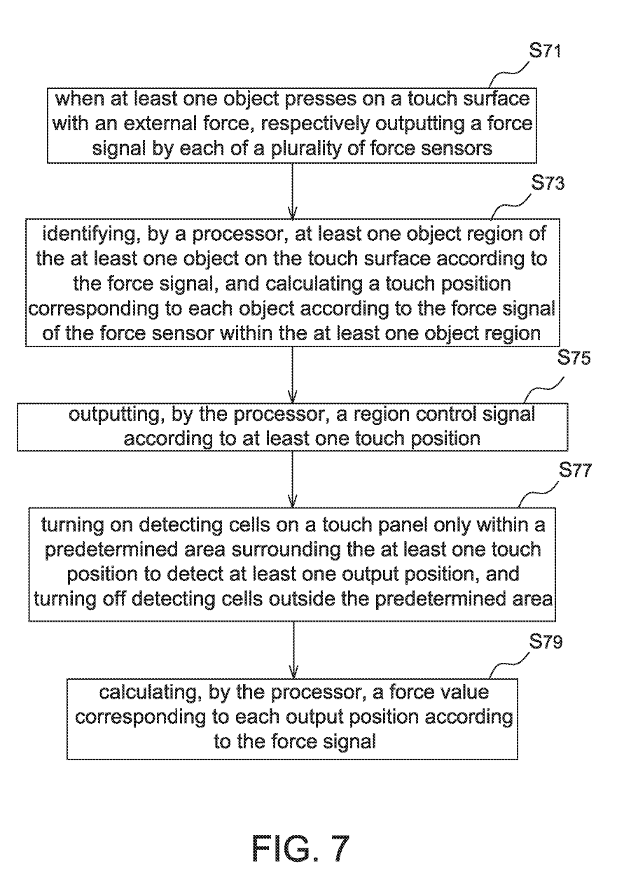

Referring to FIG. 7, it is a flow chart of a coordinate detection method of a coordinate detection device according to one embodiment of the present disclosure. The coordinate detection method is adaptable to the coordinate detection device of the first embodiment (e.g., FIG. 1) or the second embodiment (e.g., FIGS. 5 and 6). The coordinate detection method of this embodiment includes the steps of: when at least one object presses on a touch surface with an external force, respectively outputting a force signal by each of a plurality of force sensors (Step S71); identifying, by a processor, at least one object region of the at least one object on the touch surface according to the force signal, and calculating a touch position corresponding to each object according to the force signal of the force sensor within the at least one object region (Step S73); outputting, by the processor, a region control signal according to the at least one touch position (Step S75); turning on detecting cells on a touch panel only within a predetermined area surrounding the at least one touch position to detect at least one output position, and turning off detecting cells outside the predetermined area (Step S77); and calculating, by the processor, a force value corresponding to each output position according to the force signal (Step S79).

In this embodiment, the Steps S71 and S73 are adaptable to the coordinate detection device 1 of the first embodiment, the Steps S71, S73, S75 and S77 are adaptable to the coordinate detection device 5 of the second embodiment, and the Step S79 is selectively adapted to the first and second embodiments without particular limitations.

Referring to FIGS. 1 to 7, the coordinate detection method of this embodiment is illustrated hereinafter.

Step S71: Firstly, the force detection device 11 is turned on (e.g., when the coordinate detection device of this embodiment further has the touch panel 53 as shown in FIG. 5, the touch panel 53 not being turned on now), and the force detection device 11 outputs force signals P(i,j) detected by a plurality of force sensors (e.g., force values P₁₁ to P₄₅) at a scan period. When there is no object (e.g., the finger 9 shown in FIG. 2) on the touch surface 1121, the processor 114 identifies that all the force signals P(i,j) are smaller than a first threshold TH1; whereas, when at least one object 9 presses on the touch surface 1121, the processor 114 identifies that at least one of the force signals P(i,j) exceeds the first threshold TH1 (as shown in FIG. 4A), wherein said first threshold TH1 is dynamically determined according to the noise strength. Meanwhile, the procedure enters the Step S73.

Step S73: Then, the processor 114 identifies at least one touch position according to the at least one force signal P(i,j) that exceeds the first threshold TH1. As mentioned above, the processor 114 determines the at least one touch position (e.g., Ts) according to a maximum value, the interpolation or a gravity center of the at least one force signal P(i,j) that exceeds the first threshold TH1. In another embodiment, the processor 114 identifies at least one object region of the at least one object on the touch surface 1121 according to the force signals P(i,j), and calculates a touch position corresponding to each object according to the force signals P(i,j) of the force sensors 1123 within the at least one object region. In addition, as mentioned above to increase the identification accuracy, the processor 114 filters the force signals P(i,j) using a digital filter before comparing the force signals P(i,j) with the first threshold TH1, wherein details of the digital filter have been illustrated above and thus are not repeated herein.

As mentioned above, when a single touch control is being identified, the processor 114 identifies the at least one touch position based on a maximum value, the interpolation or a gravity center of multiple force signals P(i,j), among the filtered force signals, larger than a first threshold TH1; or, the processor 114 identifies a region of multiple filtered force signals P(i,j), among all filtered force signals, larger than the first threshold TH1 as at least one object region, and calculates the touch position corresponding to each object using the filtered force signals within the at least one object region by the interpolation or gravity center. When a multi touch control is performed, the processor 114 identifies a touch region according to multiple force signals, among all filtered force signals, larger than the first threshold TH1, and when an area of the touch region is larger than a scale threshold, the object segmentation is performed. In one embodiment, the processor 114 identifies multiple object regions according to a comparison result of comparing the filtered force signals within the touch region with a second threshold TH2 (e.g., as shown in FIG. 4B), wherein the first threshold TH1 and the second threshold TH2 are preferably preset and stored in the memory 116 before shipment, and the second threshold TH2 is different from the first threshold TH1. The second threshold TH2 is selected to be larger or smaller than the first threshold TH1 according to the algorithm processed by the processor 114. In some embodiments, the first threshold TH1 and the second threshold TH2 are adjustable by a user via a user interface.

In the embodiment without the touch panel (e.g., the component 53 shown in FIG. 5), the at least one touch position determined by the processor 114 according to the force signals P(i,j) is sent to an electronic device 13. In addition, according to the requirement, the processor 114 further performs the calculation of the force value corresponding to the at least one touch position of the Step S79. As mentioned above, the force value is a sum, an average or a weighted average of the force signals P(i,j) associated with each touch position without particular limitations. The force value is also outputted to the electronic device 13 for the corresponding control.

Step S75: In the embodiment including the touch panel 53, the processor 114 does not directly output the at least one touch position determined according to the force signals P(i,j) to the electronic device 13, but outputs a region control signal to the touch panel 53 according to at least one touch position.

Step S77: Accordingly, the processor 114 turns on detecting cells (e.g., Tc) on the touch panel 53 only corresponding to a predetermined area (e.g., WOI in FIG. 6) surrounding the at least one touch position (e.g. Tr in FIG. 6) according to the region control signal to detect at least one fine position, and turns off other detecting cells outside the predetermined area. More specifically, the detecting region on the touch panel 53 being turned on only includes a part of all detecting cells instead of all detecting cells such that the total power consumption is reduced.

The processor 114 takes the at least one fine position detected by the touch panel 53 as at least one output position to be sent to the electronic device 13 for the corresponding control instead of outputting the at least one touch position (or referred to rough position) detected by the force detection device 51.

Step S79: According to the requirement, the processor 114 further calculates the force value corresponding to the at least one object (i.e. the fine position) to be sent to the electronic device 13 for the corresponding control. Similarly, the force value corresponding to the at least one fine position is obtained according to a sum, an average or a weighted average of the force signals (exceeding or not exceeding the above first threshold TH1) close to the at least one fine position.

It should be mentioned that although FIG. 7 shows that the coordinate detection method takes the touch position detected by the force sensors as an example for illustration, the present disclosure is not limited thereto. As described in the second embodiment, the processor 514 identifies at least one object region according to the force signals P(i,j) without calculating the touch position in the object region. The processor 514 outputs a region control signal according to the at least one object region, and turns on detecting cells on the touch panel 53 only corresponding to the at least object region to detect at least one output position but turns off detecting cells not corresponding to the at least one object region.

In the descriptions of the present disclosure, the corresponding control includes, for example, moving cursor, clicking icon, dragging item, flipping pages and so on.

In the descriptions of the present disclosure, when the coordinate detection device does not include a touch panel, the force value corresponding to each object is corresponded to at least one touch position detected by the force detection device (e.g., component 1 in FIG. 1). When the coordinate detection device includes a touch panel, the force value corresponding to each object is corresponded to at least one fine position detected by the touch panel (e.g., component 53 in FIGS. 5 and 6).

In an embodiment that the touch panel is a self-capacitance device, only a part of touch coordinates among multiple touch coordinates (or touch positions) detected by the self-capacitance device is selected as the output coordinate which is used to perform the corresponding control. Other non-selected touch coordinates are taken as the ghost point detected by the self-capacitance device and not used to perform the corresponding control to avoid error.

Referring to FIGS. 5 and 6 again, the touch panel 53 is assumed to be a self-capacitance device used to detect multiple touch coordinates of multiple objects on the touch surface 1121, e.g., using the conventional method for detecting the touch coordinate by a self-capacitance device. The force detection device 51 also includes a plurality of force sensors (e.g., P₁₁ to P₃₄ in FIG. 5) arranged below the touch surface 1121. When the multiple objects press on the touch surface 1121 with an external force, each of the plurality of force sensors outputs a force signal P(i,j) corresponding to the external force, e.g., at least one force sensor being arranged close to each capacitor.

The processor 514 is electrically coupled to the force detection device 51 and the self-capacitance device, and selects a part of the touch coordinates from the multiple touch coordinates as the output coordinate according to the force signals P(i,j) corresponding to the multiple touch coordinates. As mentioned above, as the self-capacitance device has the problem of detecting ghost points, the error detection caused by the ghost point is eliminated by the present disclosure.

In this embodiment, the force signals P(i,j) corresponding to the multiple touch coordinates are referred to a sum or an average of force signals P(i,j) within a predetermined distance (e.g., a distance on the plane of the touch surface 1121) from each of the multiple touch coordinates. For example, when receiving the multiple touch coordinates from the self-capacitance device, the processor 514 calculates a sum or an average of force signals, among the plurality of force signals from the force detection device 51, close to each of the multiple touch coordinates so as to obtain a same number of sums or averages as a number of the multiple touch coordinates. The processor 514 selects not to process the force signals outside the predetermined distance from the multiple touch coordinates. It is appreciated that when there is only one force sensor within the predetermined distance, said sum or average is the force signal detected by said one force sensor.

There is no particular limitation on the sequence for transmitting detected signals to the processor 514 by the force detection device 51 and the self-capacitance device.

Next, the processor 514 calculates again an average or a sum of all sums or averages of the force values corresponding to each of all touch coordinates, and takes a ratio of the further calculated average or sum as a threshold, wherein the ratio is from 0.5 to 0.7 for example, but not limited thereto. In this embodiment, said threshold is a fixed value or a dynamically adjustable value according to different applications.

Finally, the processor 514 respectively compares each of the force signals corresponding to the multiple touch coordinates with the threshold, and takes touch coordinates corresponding to the force signals, among the force signals corresponding to the multiple touch coordinates, larger than the threshold as the output coordinate. More specifically, the touch coordinate, among the multiple touch coordinates, corresponding to the force signals smaller than the threshold is considered as a ghost point without being outputted.

It should be mentioned that values in the above embodiments, e.g., a number of the force sensors 1123, a number of the objects, the dimension and weighting of the digital filter F_{3×3} (e.g., equation 1), the spatial relationship between components (e.g., sensing pitch D₁ and D₂) and touch positions (e.g., Ts, Tₘ₁, Tₘ₂ and Tr) are only intended to illustrate but not to limit the present disclosure. In addition, although the above embodiments show that the force sensors 1123 are arranged as a rectangular shape corresponding to the touch surface 1121, the present disclosure is not limited thereto. In other embodiments the force sensors 1123 are arranged in other shapes and not limited to those shown in FIGS. 3 and 5.

In the descriptions of the present disclosure, as the resolution of the force sensors 1123 is smaller than the resolution of the detecting cells Tc of the touch panel 53, it is said herein that the touch position detected by the force sensors 1123 is a rough position and the position detected by the touch panel 53 is a fine position. Or, the processor 114 determines, using a simpler calculation, an object region according to the force signals P(i,j) of the force sensors 1123 and determines the output position according to the touch panel 53. Accordingly, the touch position obtained according to the force sensors 1123 is referred herein as a rough position and the position detected by the touch panel 53 is referred herein as a fine position.

It is appreciated that although FIG. 6 shows that an area of the touch surface 1121 is larger than that of the touch panel 53, it is only intended to illustrate but not to limit the present disclosure. In some embodiments, the area of the touch surface 1121 is substantially identical to that of the touch panel 53.

As mentioned above, the conventional input device independently uses the touch panel to detect position information, and thus all detecting cells of the touch panel are always turned on. Accordingly, the present disclosure provides a coordinate detection device (FIGS. 1 and 5) and a coordinate detection method (FIG. 7) that calculate the final coordinate of each touch point using a plurality of force signals of a force sensor array without using a touch panel, or that calculate the object region of each touch point using the plurality of force signals of the force sensor array with only a part of detecting cells of the touch panel being turned on.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. A coordinate detection device, configured to detect at least one touch position of at least one object on a touch surface thereof, the coordinate detection device comprising:
a force detection device comprising a plurality of force sensors arranged under the touch surface, and each of the force sensors configured to output a force signal corresponding to an external force when the at least one object presses on the touch surface with the external force; and
a processor electrically coupled to the force sensors, and configured to
identify at least one object region of the at least one object on the touch surface according to the force signal, and
respectively calculate a touch position corresponding to each of the object according to the force signal of the force sensor within the at least one object region.

2. The coordinate detection device as claimed in claim 1, wherein a value of the force signal is positively correlated with an amount of the external force.

3. The coordinate detection device as claimed in claim 1, wherein the processor is configured to identify a maximum value of force signals of the plurality of force sensors and a predetermined area surrounding the maximum value as a single object region.

4. The coordinate detection device as claimed in claim 3, wherein the processor is configured to filter the force signals using a digital filter before identifying the maximum value.

5. The coordinate detection device as claimed in claim 1, wherein the processor is configured to
identify multiple force signals, among force signals of the plurality of force sensors, larger than a first threshold as the at least one object region, and
calculate, by interpolation operation, the touch position corresponding to each of the object using the force signal within the at least one object region.

6. The coordinate detection device as claimed in claim 5, wherein the processor is configured to filter the force signals of the plurality of force sensors using a digital filter before comparing the force signals with the first threshold.

7. The coordinate detection device as claimed in claim 1, wherein the processor is configured to
identify a touch region according to multiple force signals, among force signals of the plurality of force sensors, larger than a first threshold, and
identify multiple object regions according to a comparison result of comparing the force signal within the touch region with a second threshold, which is different from the first threshold.

8. The coordinate detection device as claimed in claim 1, wherein the processor is further configured to calculate a force value corresponding to each touch position according to the force signal.

9. A coordinate detection device, configured to detect at least one touch position of at least one object on a touch surface thereof, the coordinate detection device comprising:
a force detection device comprising a plurality of force sensors arranged under the touch surface, and each of the force sensors configured to output a force signal corresponding to an external force when the at least one object presses on the touch surface with the external force;
a processor electronically coupled to the force sensors, and configured to
identify at least one object region of the at least one object on the touch surface according to the force signal, and
output a region control signal according to the at least one object region; and
a touch panel comprising a plurality of detecting cells under the touch surface, and configured to turn on detecting cells, among the plurality of detecting cells, corresponding to the at least one object region according to the region control signal to detect at least one fine position.

10. The coordinate detection device as claimed in claim 9, wherein the plurality of detecting cells of the touch panel is turned off before the region control signal is received.

11. The coordinate detection device as claimed in claim 9, wherein the processor is further configured to calculate a force value corresponding to each fine position according to the force signal.

12. The coordinate detection device as claimed in claim 9, wherein
the processor is configured to identify multiple force signals, among force signals of the plurality of force sensors, larger than a first threshold as the at least one object region, and
the touch panel is configured to turn on the detecting cells, among the plurality of detecting cells, only corresponding to the at least one object region according to the region control signal to detect the at least one fine position, and turn off detecting cells, among the plurality of detecting cells, not corresponding to the at least one object region.

13. The coordinate detection device as claimed in claim 12, wherein the processor is configured to filter the force signals of the plurality of force sensors using a digital filter before comparing the force signals with the first threshold.

14. The coordinate detection device as claimed in claim 9, wherein the processor is configured to
identify a touch region according to multiple force signals, among force signals of the plurality of force sensors, larger than a first threshold, and
identify multiple object regions according to a comparison result of comparing the force signal within the touch region with a second threshold, which is different from the first threshold.

15. The coordinate detection device as claimed in claim 9, wherein the processor is configured to identify at least one local extreme of multiple force signals, among force signals of the plurality of force sensors, larger than a first threshold and a predetermined area surrounding the at least one local extreme as the at least one object region.

16. A coordinate detection method of a coordinate detection device, the coordinate detection device comprising a touch surface, a plurality of force sensors arranged under the touch surface and a processor, the coordinate detection method comprising:
respectively outputting, by each of the force sensors, a force signal when at least one object presses on the touch surface with an external force, wherein a value of the force signal is positively correlated with an amount of the external force; and
identifying, by the processor, at least one object region of the at least one object on the touch surface according to the force signal, and calculating, by the processor, a touch position corresponding to each of the object according to the force signal of the force sensor within the at least one object region.

17. The coordinate detection method as claimed in claim 16, wherein the identifying further comprises:
filtering force signals of the plurality of force sensors using a digital filter;
identifying multiple filtered force signals, among all filtered force signals, larger than a first threshold as the at least one object region; and
calculating, by interpolation operation, the touch position corresponding to each of the object using the filtered force signals within the at least object region.

18. The coordinate detection method as claimed in claim 16, wherein the identifying further comprises:
filtering force signals of the plurality of force sensors using a digital filter;
identifying a touch region according to multiple filtered force signals, among all filtered force signals, larger than a first threshold; and
identifying multiple object regions according to a comparison result of comparing the filtered force signals within the touch region with a second threshold, which is different from the first threshold.

19. The coordinate detection method as claimed in claim 16, wherein the coordinate detection device further comprises a touch panel which comprises a plurality of detecting cells, and the coordinate detection method further comprises:
outputting, by the processor, a region control signal according to at least one touch position; and
turning on detecting cells corresponding to a predetermined area surrounding the at least one touch position according to the region control signal to detect at least one output position, and turning off detecting cells not within the predetermined area.

20. The coordinate detection method as claimed in claim 19, further comprising:
calculating, by the processor, a force value corresponding to each output position according to the force signal.

21. A coordinate detection device, comprising:
a self-capacitance device configured to detect multiple touch coordinates of multiple objects on a touch surface;
a force detection device comprising a plurality of force sensors arranged under the touch surface, and each of the force sensors configured to output a force signal corresponding to an external force when the multiple objects press on the touch surface with the external force; and
a processor electrically coupled to the force detection device and the self-capacitance device, and configured to select a part of touch coordinates among the multiple touch coordinates as output coordinates according to force signals corresponding to the multiple touch coordinates.

22. The coordinate detection device as claimed in claim 21, wherein the force signals corresponding to the multiple touch coordinates are a sum or an average of force signals within a predetermined distance of each of the multiple touch coordinates.

23. The coordinate detection device as claimed in claim 21, wherein the processor is configured to
take a ratio of an average of the force signals corresponding to the multiple touch coordinates as a threshold value, and
take touch coordinates corresponding to the force signals, among the force signals corresponding to the multiple touch coordinates, larger than the threshold value as the output coordinates.
